(19) United States
(12) Patent Application Publication
(10) Pub. No.: US 2008/0082687 A1
(43) Pub. Date: Apr. 3, 2008

(54) METHOD, SYSTEM, AND COMPUTER PROGRAM PRODUCT FOR IMPLEMENTING COLLABORATIVE CORRECTION OF ONLINE CONTENT

(76) Inventors: Ryan Kirk Cradick, Rochester, MN (US); Zachary Adam Garbow, Rochester, MN (US)

Correspondence Address: IBM CORPORATION;ROCHESTER IP LAW DEPT 917, 3605 HIGHWAY 52 N, ROCHESTER, MN, 55901-7829, US

(21) Appl. No.: 11/536,144

(22) Filed: Sep. 28, 2006

(51) Int. Cl. G06F 15/16; G06F 15/173

(52) U.S. Cl. 709/246; 709/223; 709/204

(57) ABSTRACT

Methods and computer program product are provided for implementing collaborative correction of online content. A user of a web page is enabled to flag a location of an error and a category of the error. A web server logs error data into a database. A notification is sent to a web page administrator. Error data is cleared from the database responsive to the web page administrator fixing the error.

### FIELD OF THE INVENTION

The present invention relates generally to the data processing field, and more particularly, relates to a method, system and computer program product for implementing collaborative correction of online content.

### DESCRIPTION OF THE RELATED ART

The Internet has enabled anyone with an online connection to become a potential content publisher. This has been beneficial in the sense of putting a great amount of information into a freely accessible format; however, it has subsequently presented drawbacks in the quality of the content published. Many web pages contain inadvertent errors in spelling, facts, link locations, formatting, grammar, and the like. Oftentimes, the content publisher does not realize these errors exist, and most users will not take the time to email a stranger in order to inform them of a spelling error, for instance.

Within a corporate website or intranet and even a small business website, minor errors can be harmful to a company's reputation or that of the content provider.

Wikis and other forms of collaborative communications provide the ability for users to edit a page, for example, as used in Wikipedia, an encyclopedia written collaboratively by many of its readers. However, these forms of content publishing have the intent of being fully collaborative, rather than enabling fast feedback to a content publisher. In many instances, fully collaborative editing is undesirable for many content publishers.

A need exists for an effective mechanism for implementing collaborative correction of online content.

### SUMMARY OF THE INVENTION

A principal aspect of the present invention is to provide a method and computer program product for implementing collaborative correction of online content. Other important aspects of the present invention are to provide such method and computer program product for implementing collaborative correction of online content substantially without negative effect and that overcome many of the disadvantages of prior art arrangements.

In brief, methods and computer program product are provided for implementing collaborative correction of online content. A user of a web page is enabled to flag a location of an error and a category of the error. A web server logs error data into a database. A notification is sent to a web page administrator. Error data is cleared from the database responsive to the web page administrator fixing the error.

In accordance with features of the invention, a number of flags in a region of interest (ROI) is compared with a threshold, and the notification is sent to a web page administrator when the number exceeds the threshold. A number of flags for a defined error category within a region of interest (ROI) is compared with a threshold, and the notification is sent to a web page administrator when the number exceeds the threshold.

In accordance with features of the invention, responsive to a user flagging a location of an error and a category of the error, predefined data related to the error and the user are sent to the web server. The predefined data includes at least one of a URL of the web page, the location or a region of interest (ROI) of the error, and the category of the error, an IP address of the user.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1 is a bock diagram representation illustrating an exemplary network system for implementing enhanced collaborative correction of online content in accordance with the preferred embodiment;

FIGS. 2A, and 2B are flow charts illustrating exemplary steps for implementing enhanced collaborative correction of online content in accordance with the preferred embodiment; and

FIG. 3 is a block diagram illustrating a computer program product in accordance with the preferred embodiment.

### DETAILED DESCRIPTION OF THE PREFERRED EMBODIMENTS

In accordance with features of the invention, a method of collaboration is provided to easily mark errors within an online environment, and as such presents great value to content publishers, providers, and creators of infrastructure and middleware. The invention provides a method for fast, collaborative feedback regarding a web page's correctness, along with result filtering and threshold notifications.

In accordance with features of the invention, this method allows visitors of a site to quickly flag the location of an error and easily categorize it. The results of users' flag are aggregated over time, and once a particular location, or range, has exceeded a defined threshold for number of flags or rate of flags, the content author is notified of the potential content error. This method can further be used to improve search results. Search engines could favor content that has this feature enabled since it will provide more correct content via the collaborative corrections. For example, search engines advantageously give preference to web pages utilizing a system implementing the collaborative error feedback method of the invention, as it encourages correctness of the content and reduces the number of broken links.

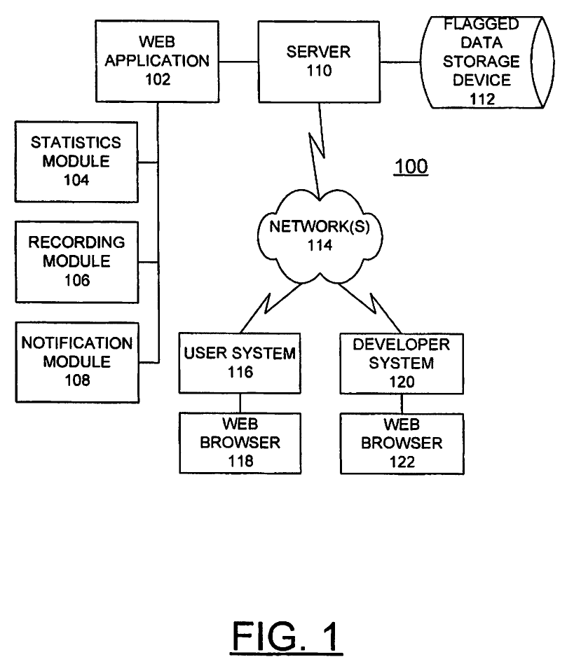

Having reference now to the drawings, in FIG. 1, there is shown a network system generally designated by the reference character 100 for implementing enhanced collaborative correction of online content in accordance with the preferred embodiment. System 100 includes a web application 102 for implementing enhanced collaborative correction of online content in accordance with the preferred embodiment. A statistics module 104, a recording module 106, and a notification module 108 are associated with the web application 102 in accordance with the preferred embodiment. System 100 includes a web server computer 110 and an associated flagged data storage device 112. The web server computer 110 is coupled via a network or networks 114 to a user system 116 that includes a web browser 118 and a developer system 120 that includes a web browser 122.

In accordance with features of the invention, the method works in concert between the site visitors' browser 118 and the web server 110 hosting the content. When a user visits a site and spots an error, which can be spelling, broken link, grammar, factual, formatting error and the like, the users are allowed to flag the location, for example, a single point, or lassoed area of the error and to categorize the error. This can be implemented using various methods including for example, an AJAX platform, while the net effect remains the same. The content provider, allowing the user to choose the error type, advantageously predefines potential categories of errors. Alternatively, the user can fill in an error category ad hoc. The flag is then submitted to the web server 110 and the user continues browsing the site of web application 102. A visual representation of this flag can optionally persist on the site for the user who flagged it.

Once submitted, the flagged location and category is aggregated on the server with other submitted flags. The flagged location is saved within a database, for example, stored in the flagged data storage device 112, including the page location, the resources surrounding the flag location in the page with respect to the source code, that is surrounding words, link, images, and the like, IP address of the submitter, and the error category as selected by the user.

Server 110 compares aggregated flagged results against thresholds defined by the content publisher. If the number of flags overall, or of a particular category, exceeds a threshold, the specified contact person or web page administrator is notified. This person is made aware of the potential error and then can make subsequent fixes to the page. After the specified contact person or web page administrator fixes the error or confirms that no error is present, the associated flags are then cleared from the database or archived.

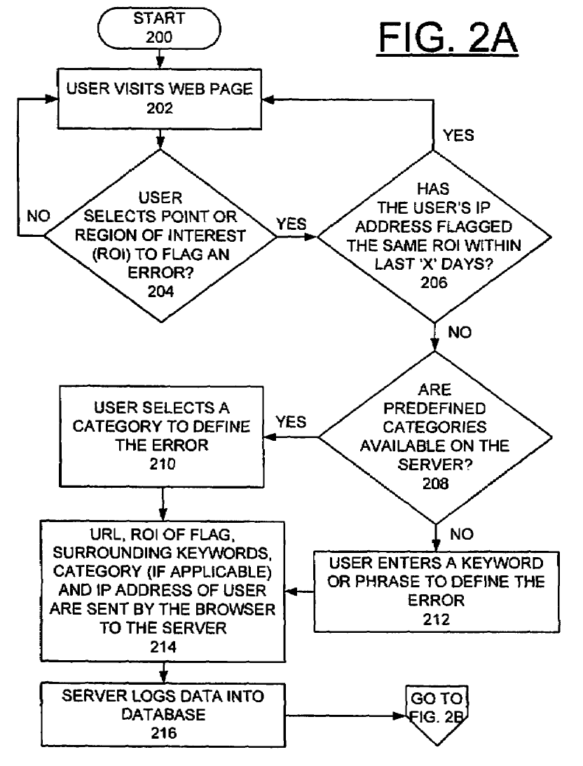

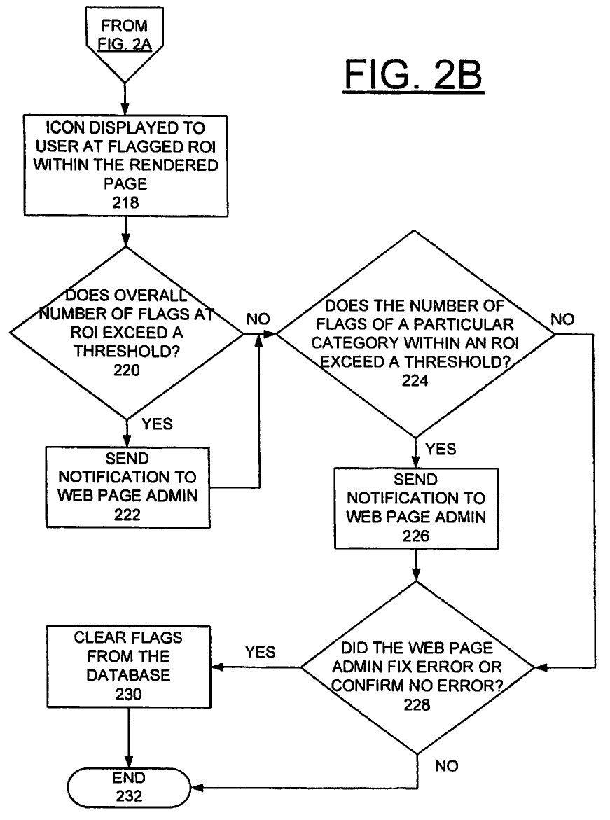

Referring now to FIGS. 2A, and 2B, there are shown exemplary steps for implementing enhanced collaborative correction of online content in accordance with the preferred embodiment starting at a block 200. A user visits a web page as indicated in a block 202. As indicated in a decision block 204, checking for a user selecting a point or region of interest (ROI) to flag an error is performed. When the user selects a point or region of interest (ROI) to flag an error, then checking whether the user's IP address has flagged the same ROI within a set number of days is performed as indicated in a decision block 206. If not, then checking for predefined error categories are available on the server as indicated in a decision block 208. When predefined error categories are available, the user selects a category to define the error as indicated in a block 210. Otherwise, the user enters a keyword or phrase to define the error as indicated in a block 212. Then the browser 116 sends the URL, ROI of the error flag, surrounding keywords, category if applicable, and IP address of the user to the server 110 as indicated in a block 214. The server 110 logs data into the database as indicated in a block 216.

Referring to FIG. 2B, next an icon is displayed to the user at the flagged ROI within the rendered page as indicated in a block 218. Checking whether the overall number of flags at the ROI exceed a threshold is performed as indicated in a decision block 220. If so, then a notification is sent to the web page administrator as indicated in a block 222. Otherwise, when the overall number of flags at the ROI does not exceed the threshold, checking whether a number of flags of a particular category exceed a threshold is performed as indicated in a decision block 224. When the number of flags of a particular category exceeds the threshold, then a notification is sent to the web page administrator as indicated in a block 226. Otherwise, when the overall number of flags of a particular category at the ROI does not exceed the threshold, checking whether the web page administrator has fixed the error or confirmed that no error is present is performed as indicated in a decision block 228. When the web page administrator has fixed the error or confirmed that no error is present, then the flags are cleared form the database as indicated in a block 230. The exemplary steps return or end as indicated in a block 232.

In brief summary, advantages of this method to web content publishers include: Community involvement to reduce errors; fast and easy for the user, thus increasing participation; abstracts the feedback from the user; filters results via thresholds, maintains site correctness; improved search results; and the web administration can generate reports and track usage. Methods for implementing enhanced collaborative correction of online content in accordance with the preferred embodiment provide a valuable enhancement to corporate intranets, web hosting providers, website creators, middleware offerings, and service providers.

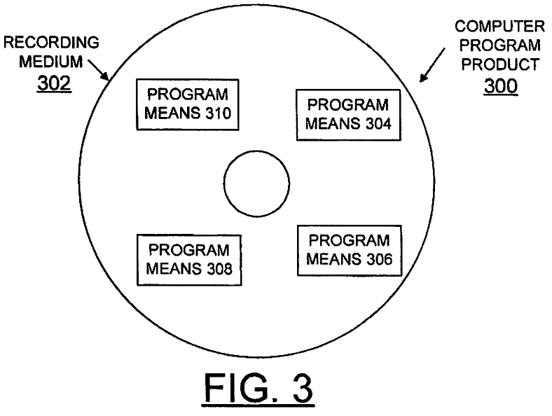

Referring now to FIG. 3, an article of manufacture or a computer program product 300 of the invention is illustrated. The computer program product 300 includes a recording medium 302, such as, a floppy disk, a high capacity read only memory in the form of an optically read compact disk or CD-ROM, or a tape. Recording medium 302 stores program means 304, 306, 308, 310 on the medium 302 for carrying out the methods for implementing enhanced collaborative correction of online content of the preferred embodiment in the system 100 of FIG. 1.

A sequence of program instructions or a logical assembly of one or more interrelated modules defined by the recorded program means 304, 306, 308, 310, direct the computer system 100 for implementing enhanced collaborative correction of online content of the preferred embodiment.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems.

While the present invention has been described with reference to the details of the embodiments of the invention shown in the drawing, these details are not intended to limit the scope of the invention as claimed in the appended claims.

What is claimed is:

1. A method for implementing collaborative correction of online content comprising:
enabling a user of a web page to flag a location of an error and a category of the error;
utilizing a web server, logging error data into a database;
sending an error notification to a web page administrator; and
clearing error data from the database responsive to the web page administrator fixing the error.

2. A method for implementing collaborative correction of online content as recited in claim 1 includes the web server aggregates flagged error data into the database, and stores a flag for each error within a region of interest (ROI).

3. A method for implementing collaborative correction of online content as recited in claim 2 includes the web server comparing a number of flags in a region of interest (ROI) with a threshold.

4. A method for implementing collaborative correction of online content as recited in claim 3 wherein said notification is sent to the web page administrator when the number of flags within the region of interest (ROI) exceeds the threshold.

5. A method for implementing collaborative correction of online content as recited in claim 1 includes the web server aggregates the flagged error data into the database, and stores a flag for each error of a defined error category within a region of interest (ROI).

6. A method for implementing collaborative correction of online content as recited in claim 5 includes the web server comparing a number of flags of the defined error category in a region of interest (ROI) with a threshold.

7. A method for implementing collaborative correction of online content as recited in claim 6 wherein said notification is sent to the web page administrator when the number of flags of the defined error category within the region of interest (ROI) exceeds the threshold.

8. A method for implementing collaborative correction of online content as recited in claim 1 includes sending predefined data related to an error and the user to the web server, responsive to a user flagging a location of an error and a category of the error.

9. A method for implementing collaborative correction of online content as recited in claim 8 wherein sending predefined data to the web server includes sending at least one of: a URL of the web page, the location of the error, a region of interest (ROI) of the error, the category of the error, an IP address of the user.

10. A network system for implementing collaborative correction of online content comprising:
a network;
a web server coupled to the network hosting a web application; said web application including a statistics module, a recording module and a notification module;
a user system coupled to the network; said user system including a browser enabling a user of a web page to flag a location of an error and a category of the error;
said web server receiving and logging error data into a database;
said web server sending an error notification to a web page administrator; and
said web server clearing error data from the database responsive to the web page administrator fixing the error.

11. A network system for implementing collaborative correction of online content as recited in claim 10 wherein said web server aggregates flagged error data into the database, and stores a flag for each error within a region of interest (ROI).

12. A network system for implementing collaborative correction of online content as recited in claim 11 wherein said web server compares a number of flags within the region of interest (ROI) with a threshold; and sends the error notification to the web page administrator when the number of flags within the region of interest (ROI) exceeds the threshold.

13. A network system for implementing collaborative correction of online content as recited in claim 11 wherein said web server stores a flag for each error of a defined category within the region of interest (ROI), compares the number of flags of the defined error category in a region of interest (ROI) with a defined threshold, and sends the error notification to the web page administrator when the number of flags of the defined category within the region of interest (ROI) exceeds the threshold.

14. A network system for implementing collaborative correction of online content as recited in claim 10 wherein the web browser sends predefined data to the web server responsive to a user flagging a location of an error and a category of the error.

15. A network system for implementing collaborative correction of online content as recited in claim 11 wherein the web browser sends at least one of: a URL of the web page, the location of the error, a region of interest (ROI) of the error, the category of the error, and an IP address of the user.

16. A computer program product for implementing enhanced collaborative correction of online content, said computer program product including instructions stored on a computer readable storage medium, said instructions when executed by a web server to cause the web server to perform the steps of:
receiving error data from a user of a web page; said error data including a location of an error and a category of the error;
logging error data into a database;
sending an error notification to a web page administrator; and
clearing error data from the database responsive to the web page administrator fixing the error.

17. A computer program product for implementing enhanced collaborative correction of online content as recited in claim 16 further includes the web server aggregating flagged error data into the database, and storing a flag for each error within a region of interest (ROI).

18. A computer program product for implementing enhanced collaborative correction of online content as recited in claim 17 stores a flag for each error of a defined error category within a region of interest (ROI).

19. A computer program product for implementing enhanced collaborative correction of online content as recited in claim 18 further includes comparing a number of flags with a first threshold and comparing a number of flags of the defined error category in a region of interest (ROI) with a second threshold, and wherein said notification is sent to the web page administrator when one of the first or second threshold is exceeded.

20. A computer program product for implementing enhanced collaborative correction of online content as recited in claim 16 wherein receiving error data from a user of a web page includes receiving at least one of: a URL of the web page, the location of the error, a region of interest (ROI) of the error, the category of the error, an IP address of the user.
